(19) United States
(12) Patent Application Publication
(10) Pub. No.: US 2025/0111969 A1
(43) Pub. Date: Apr. 3, 2025

(54) ELECTRONIC COMPONENT

(71) Applicant: TDK Corporation, Tokyo (JP)

(72) Inventors: Nobuyuki OKUZAWA, Tokyo (JP); Ryuji HASHIMOTO, Tokyo (JP); Yuiko HIROSE, Tokyo (JP); Yuta TAKAHASHI, Tokyo (JP); Hiroki HOSAKA, Tokyo (JP); Koki ENDO, Tokyo (JP)

(73) Assignee: TDK Corporation, Tokyo (JP)

(21) Appl. No.: 18/892,837

(22) Filed: Sep. 23, 2024

(30) Foreign Application Priority Data
Sep. 29, 2023 (JP) 2023-169161

(51) Int. Cl. H01F 5/04; H01F 1/03; H01F 5/06; H01F 17/02

(52) U.S. Cl. CPC H01F 5/04; H01F 1/0306; H01F 5/06; H01F 17/02

(57) ABSTRACT

A coil component includes an element body formed by laminating a plurality of insulator layers, and a pillar part disposed in the element body and extending in a lamination direction of the plurality of insulator layers. The pillar part has a plurality of pillar members laminated in the lamination direction. Between the two pillar members in the lamination direction, a defining part that defines a contact surface between the two pillar members is provided. The defining part is formed of a material different from a material of the pillar part, and is disposed at edges of the two pillar members when viewed from the lamination direction.

### TECHNICAL FIELD

The present disclosure relates to an electronic component.

### BACKGROUND

An electronic component includes an element body formed by laminating a plurality of insulator layers, a terminal electrode disposed in the element body, and a coil disposed in the element body and electrically connected to the terminal electrode (see, e.g., WO 2016/132911). The coil includes a first wiring part, a second wiring part, and a connection part extending in a lamination direction of the plurality of insulator layers and connecting the first wiring part and the second wiring part.

### SUMMARY

The connection part (conductor) constituting the coil is formed by laminating a plurality of members. Two members laminated in a lamination direction may have misalignment in a direction (a direction parallel to surfaces of the members opposed to each other) orthogonal to the lamination direction. When the two members are misaligned, a contact area between the two members changes. Change in the contact area affects a property of the electronic component. The misalignment between the two members varies with an individual electronic component. Therefore, a property of the electronic component may vary.

An object of one aspect of the present disclosure is to provide an electronic component enabling occurrence of variations in property to be suppressed.

(1) An electronic component according to one aspect of the present disclosure includes: an element body formed by laminating a plurality of insulator layers; and a conductor disposed in the element body and extending in a lamination direction of the plurality of insulator layers. The conductor has a plurality of conductor members laminated in the lamination direction, between two of the conductor members in the lamination direction, a defining part configured to define a contact surface between the two conductor members is provided, and the defining part is formed of a material different from a material of the conductor, and is disposed at edges of the two conductor members when viewed from the lamination direction.

In the electronic component according to one aspect of the present disclosure, between two conductor members in the lamination direction, the defining part that defines the contact surface between the two conductor members is provided. The defining part is formed of a material different from that of the conductor, and is disposed at the edges of the two conductor members when viewed from the lamination direction. As a result, in the electronic component, even when misalignment in lamination occurs in the two conductor members, the contact surface between the two conductor members is defined by the defining part, and thus, a contact area of the two conductor members is kept constant. Therefore, in the electronic component, even when the two conductor members are misaligned, the property is not affected. As a result, in the electronic component, occurrence of variations in property can be suppressed.

(2) In the electronic component of (1) described above, the conductor may be formed of Cu, and the defining part may be formed of an inorganic substance different from Cu. In this configuration, since the defining part is formed of an inorganic substance different from the conductor formed of Cu, even when the two conductor members are misaligned, the property can be prevented from being affected.

(3) In the electronic component of (1) or (2) described above, the contact surface defined by the defining part may have a shape similar to an outer shape of the conductor when viewed from the lamination direction. In this configuration, a large allowable range of misalignment between the two conductor members can be secured.

(4) In the electronic component of (1) described above, the defining part may be formed of the same material as the element body. In this configuration, even when the two conductor members are misaligned, the property can be prevented from being affected.

(5) In the electronic component of (4) described above, in one conductor member of the two conductor members, a side surface of the one conductor member and the contact surface may be connected by a curved surface, and the defining part may be disposed at a position corresponding to the curved surface when viewed from the lamination direction. In this configuration, a space is formed between the two conductor members at the edges of the conductor members. Therefore, the element body can be used as the defining part.

(6) An electronic component according to one aspect of the present disclosure includes: an element body formed by laminating a plurality of insulator layers; a first conductor disposed in the element body and extending in a lamination direction of the plurality of insulator layers; and a second conductor connected to the first conductor. Between the first conductor and the second conductor, a defining part configured to define a contact surface between the first conductor and the second conductor is provided, and the defining part is formed of a material different from materials of the first conductor and the second conductor, and is disposed at edges of the first conductor when viewed from the lamination direction.

In the electronic component according to one aspect of the present disclosure, the defining part that defines the contact surface between the first conductor and the second conductor is provided between the first conductor and the second conductor. The defining part is formed of a material different from those of the first conductor and the second conductor, and is disposed at the edge of the first conductor when viewed from the lamination direction. As a result, in the electronic component, even when misalignment in lamination occurs in the first conductor and the second conductor, the contact surface between the first conductor and the second conductor are defined by the defining part, so that the contact area of the first conductor and the second conductor is kept constant. Therefore, in the electronic component, even when the first conductor and the second conductor are misaligned, the property is not affected. As a result, in the electronic component, occurrence of variations in property can be suppressed.

(7) In the electronic component of (6) described above, the first conductor and the second conductor may be formed of Cu, and the defining part may be formed of an inorganic substance different from Cu. In this configuration, since the defining part is formed of an inorganic substance different from the conductor formed of Cu, even when the first conductor and the second conductor are misaligned, the property can be prevented from being affected.

(8) In the electronic component of (6) or (7) described above, the contact surface defined by the defining part may have a shape similar to an outer shape of the first conductor when viewed from the lamination direction. In this configuration, a large allowable range of misalignment between the first conductor and the second conductor can be secured.

(9) In the electronic component of (6) described above, the defining part may be formed of the same material as a material of the element body. In this configuration, even when the first conductor and the second conductor are misaligned, the property can be prevented from being affected.

According to one aspect of the present disclosure, occurrence of variations in property can be suppressed.

### BRIEF DESCRIPTION OF THE DRAWINGS

FIG. 1 is a perspective view of a coil component according to an embodiment;

FIG. 2 is a view of the coil component illustrated in FIG. 1 as viewed from an end surface side;

FIG. 3 is an enlarged cross-sectional view illustrating a part of a pillar part of the coil component according to a first embodiment;

FIG. 4 is a view of a defining part as viewed from a lamination direction;

FIG. 5A, FIG. 5B, FIG. 5C, FIG. 5D, FIG. 5E, FIG. 5F, and FIG. 5G are views for explaining manufacture of the pillar part;

FIG. 6A is a view illustrating a state in which no misalignment occurs between two pillar members, and FIG. 6B is a view illustrating a state in which misalignment occurs between the two pillar members;

FIG. 7 is an enlarged cross-sectional view illustrating a part of a pillar part of a coil component according to a second embodiment;

FIG. 8 is a view of a defining part as viewed from the lamination direction;

FIG. 9A, FIG. 9B, FIG. 9C, FIG. 9D, FIG. 9E, and FIG. 9F are views for explaining manufacture of the pillar part;

FIG. 10 is an enlarged cross-sectional view illustrating a part of a pillar part and a wiring part of a coil component according to a third embodiment; and

FIG. 11 is an enlarged cross-sectional view illustrating a part of a pillar part and a wiring part of a coil component according to a fourth embodiment.

### DETAILED DESCRIPTION

In the following, preferred embodiments of the present disclosure will be described in detail with reference to the accompanying drawings. Note that the same or corresponding elements in the description of the drawings are denoted by the same reference signs, and redundant description thereof is omitted.

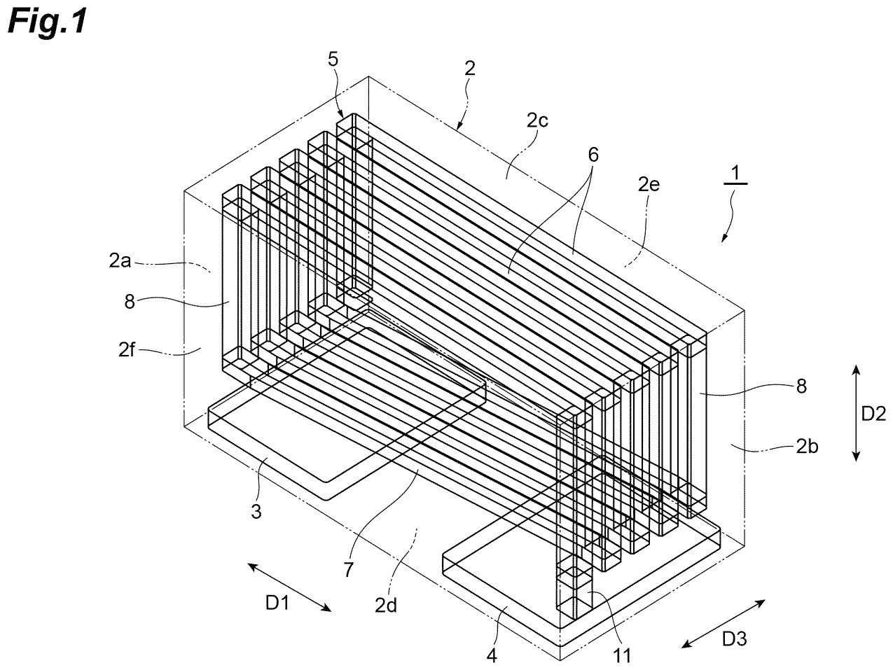

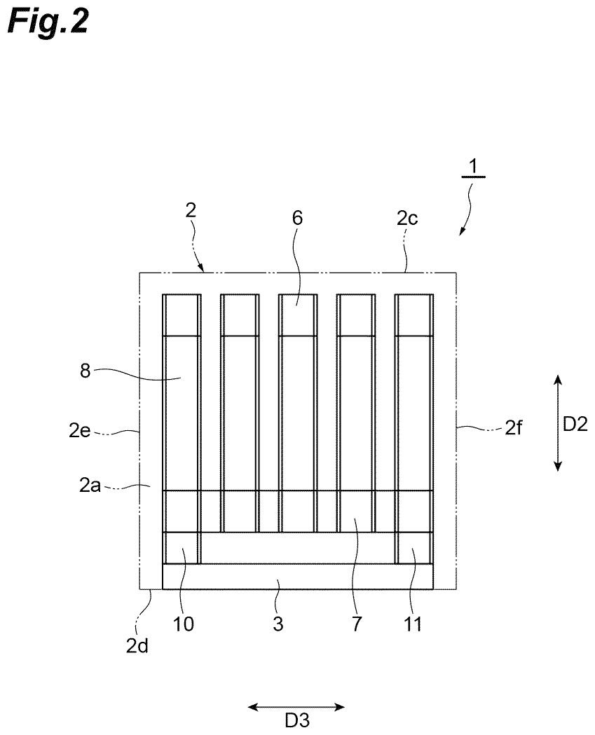

A coil component according to an embodiment will be described with reference to FIG. 1. FIG. 1 is a perspective view illustrating the coil component according to the embodiment. FIG. 2 is a view of the coil component illustrated in FIG. 1 as viewed from an end surface side. As illustrated in FIGS. 1 and 2, a coil component (electronic component) 1 includes an element body 2, a first terminal electrode 3, a second terminal electrode 4, a coil 5, a first connection conductor 10, and a second connection conductor 11. In FIGS. 1 and 2, the element body 2 is indicated by a dashed double-dotted line. In FIG. 1, the coil 5 is illustrated in a transparent manner.

The element body 2 has a rectangular parallelepiped shape. The rectangular parallelepiped shape includes a rectangular parallelepiped shape in which corner parts and ridge line parts are chamfered, or a rectangular parallelepiped shape in which corner parts and ridge line parts are rounded. The element body 2 has, as outer surfaces, a pair of end surfaces 2a and 2b, a pair of main surfaces 2c and 2d, and a pair of side surfaces 2e and 2f. The end surfaces 2a and 2b are opposed to each other. The main surfaces 2c and 2d are opposed to each other. The side surfaces 2e and 2f are opposed to each other. In the following, a direction in which the end surfaces 2a and 2b are opposed to each other is referred to as a first direction D1, a direction in which the main surfaces 2c and 2d are opposed to each other is referred to as a second direction D2, and a direction in which the side surfaces 2e and 2f are opposed to each other is referred to as a third direction D3. The first direction D1, the second direction D2, and the third direction D3 are substantially orthogonal to each other.

The end surfaces 2a and 2b extend in the second direction D2 so as to link the main surfaces 2c and 2d. The end surfaces 2a and 2b also extend in the third direction D3 so as to link the side surfaces 2e and 2f. The main surfaces 2c and 2d extend in the first direction D1 so as to link the end surfaces 2a and 2b. The main surfaces 2c and 2d also extend in the third direction D3 so as to link the side surfaces 2e and 2f. The side surfaces 2e and 2f extend in the first direction D1 so as to link the end surfaces 2a and 2b. The side surfaces 2e and 2f also extend in the second direction D2 so as to link the main surfaces 2c and 2d.

The main surface 2d is a mounting surface, and is, for example, a surface opposed to other electronic apparatus (not illustrated) (e.g., a circuit substrate or a coil component) when the coil component 1 is mounted on that other electronic apparatus. The end surfaces 2a and 2b are surfaces continuous from the mounting surface (i.e., the main surface 2d).

In a case of the mode illustrated in FIGS. 1 and 2, a length of the element body 2 in the first direction D1 is longer than a length of the element body 2 in the second direction D2 and a length of the element body 2 in the third direction D3. The length of the element body 2 in the second direction D2 is shorter than the length of the element body 2 in the third direction D3. In other words, in the present embodiment, the end surfaces 2a and 2b, the main surfaces 2c and 2d, and the side surfaces 2e and 2f each have an oblong shape. The length of the element body 2 in the second direction D2 may be equal to the length of the element body 2 in the third direction D3, or may be longer than the length of the element body 2 in the third direction D3.

It should be noted that “equal” in the present embodiment may not only mean equal but also mean equal to a value including a slight difference, a manufacturing error, or the like in a preset range. For example, when a plurality of values is included within a range of ±5% of an average value of the plurality of values, the plurality of values is defined to be equal.

The element body 2 is formed by laminating a plurality of element body layers (insulator layers) in the second direction D2. In other words, a lamination direction of the element body 2 is the second direction D2. In the actual element body 2, the plurality of element body layers may be integrated to such an extent that boundaries between the layers cannot be visually recognized, or may be integrated such that the boundaries between the layers can be visually recognized.

Each of the element body layers may be, for example, a resin layer. A material of the element body layer includes, for example, at least one selected from a liquid crystal polymer, a polyimide resin, crystalline polystyrene, an epoxy resin, an acrylic resin, a bismaleide-based resin, and a fluorine-based resin. The element body layer may contain a filler. The filler may be, for example, an inorganic filler. Examples of the inorganic filler include silica (SiO₂). Note that the element body layer may not contain a filler.

Note that the element body layer may be configured to contain a magnetic material. The magnetic material of the element body layer includes, for example, a Ni—Cu—Zn-based ferrite material, a Ni—Cu—Zn—Mg-based ferrite material, or a Ni—Cu-based ferrite material. The magnetic material of the element body layer may contain, for example, a Fe alloy. The element body layer may contain, for example, a nonmagnetic material. The nonmagnetic material of the element body layer includes, for example, a glass ceramic material or a dielectric material.

Each of the first terminal electrode 3 and the second terminal electrode 4 is provided in the element body 2. Each of the first terminal electrode 3 and the second terminal electrode 4 is disposed on the main surface 2d of the element body 2. The first terminal electrode 3 and the second terminal electrode 4 are provided in the element body 2 so as to be separated from each other in the first direction D1. Specifically, the first terminal electrode 3 is disposed on a side of the end surface 2a of the element body 2. The second terminal electrode 4 is disposed on a side of the end surface 2b of the element body 2.

Each of the first terminal electrode 3 and the second terminal electrode 4 may have, for example, an oblong shape (rectangular shape). Each of the first terminal electrode 3 and the second terminal electrode 4 is disposed such that each side is along the first direction D1 or the third direction D3. As illustrated in FIG. 2, neither the first terminal electrode 3 nor the second terminal electrode 4 protrudes from the main surface 2d. In other words, in the present embodiment, the respective surfaces of the first terminal electrode 3 and the second terminal electrode 4 are flush with the main surface 2d. The first terminal electrode 3 and the second terminal electrode 4 are made of a conductive material (e.g., Cu).

Each of the first terminal electrode 3 and the second terminal electrode 4 may be provided with a plating layer (not illustrated) containing, e.g., Ni, Sn, Au, or the like by electrolytic plating or non-electrolytic plating. The plating layer may have, for example, a Ni plating film containing Ni and covering the first terminal electrode 3 and the second terminal electrode 4, and an Au plating film containing Au and covering the Ni plating film.

As illustrated in FIGS. 1 and 2, the coil 5 is disposed in the element body 2. The coil 5 has a plurality of first wiring parts 6, a plurality of second wiring parts 7, and a plurality of pillar parts (conductors) 8. The coil 5 is formed by electrically connecting the first wiring parts 6, the second wiring parts 7, and the pillar parts 8. A coil axis of the coil 5 is provided along the third direction D3. The plurality of first wiring parts 6, the plurality of second wiring parts 7, and the plurality of pillar parts 8 are made of a conductive material (e.g., Cu). The first wiring parts 6, the second wiring parts 7, and the pillar parts 8 are disposed apart from the end surfaces 2a and 2b, the main surfaces 2c and 2d, and the side surfaces 2e and 2f.

Each of the first wiring parts 6 is disposed on a side of the main surface 2c of the element body 2. Each of the first wiring parts 6 extends along the first direction D1. Each of the first wiring parts 6 connects two pillar parts 8. The first wiring part 6 spans between the two pillar parts 8. One end (an end on the side of the end surface 2a) in an extending direction of the first wiring part 6 is connected to one end (an end on the side of the main surface 2c) of the pillar part 8. The other end (an end on the side of the end surface 2b) in the extending direction of the first wiring part 6 is connected to the one end (the end on the side of the main surface 2c) of the pillar part 8.

Each of the second wiring parts 7 is disposed on a side of the main surface 2d (the mounting surface) of the element body 2. Each of the second wiring parts 7 extends in the first direction D1. Each of the second wiring parts 7 connects two pillar parts 8. The second wiring part 7 spans between the two pillar parts 8. One end (the end on the side of the end surface 2a) in an extending direction of the second wiring part 7 is connected to the other end (the end on the side of the main surface 2d) of the pillar part 8. The other end (the end on the side of the end surface 2b) in the extending direction of the second wiring part 7 is connected to the other end (the end on the side of the main surface 2d) of the pillar part 8. The number of the plurality of second wiring parts 7 is one less than the number of the plurality of first wiring parts 6. In other words, in a case where the number of the first wiring parts 6 is n, the number of the second wiring parts 7 is n-1.

Each of the pillar parts 8 extends along the second direction D2. The pillar part 8 connects the first wiring part 6 and the second wiring part 7. In the present embodiment, the pillar part 8 has a prismatic shape. A shape of a cross section of the pillar part 8 (a direction orthogonal to the second direction D2) is rectangular. The one end of the pillar part 8 is connected to the end of the first wiring part 6. The other end of the pillar part 8 is connected to the end of the second wiring part 7.

The first connection conductor 10 connects the first terminal electrode 3 and one end of the coil 5. The first connection conductor 10 is connected to the other end of the pillar part 8 at the coil 5. The first connection conductor 10 is disposed at a position close to the end surface 2a and close to the side surface 2e. The first connection conductor 10 is made of a conductive material. The first connection conductor 10 is formed of, for example, Cu.

The second connection conductor 11 connects the second terminal electrode 4 and the other end of the coil 5. The second connection conductor 11 is connected to the other end of the pillar part 8 at the coil 5. The second connection conductor 11 is disposed at a position close to the end surface 2b and close to the side surface 2f. The second connection conductor 11 is made of a conductive material. The second connection conductor 11 is formed of, for example, Cu.

### First Embodiment

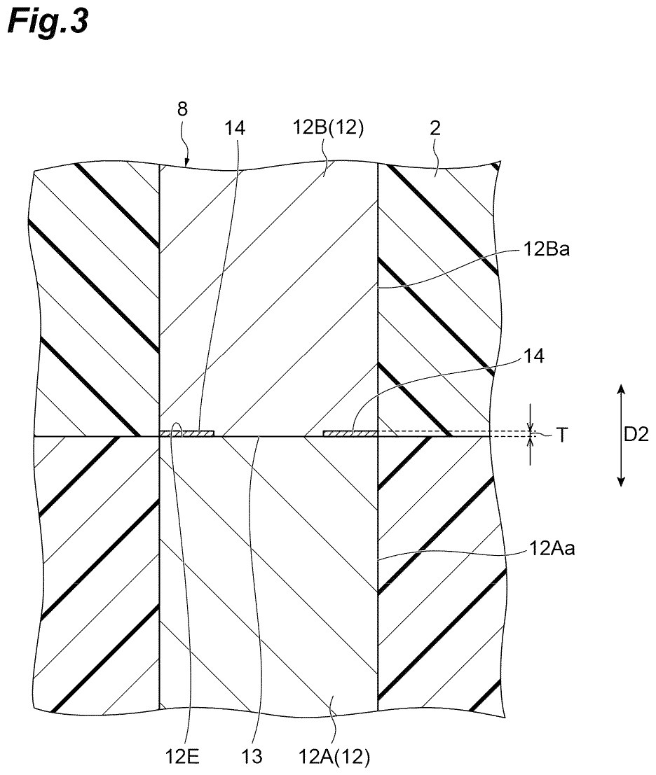

FIG. 3 is an enlarged cross-sectional view illustrating a part of the pillar part according to a first embodiment. As illustrated in FIG. 3, the pillar part 8 has a plurality of pillar members (conductor members) 12. In the pillar part 8, the plurality of pillar members 12 is laminated in the second direction D2. In the following description, for convenience of description, the plurality of pillar members 12 may be distinguished from a pillar member 12A and a pillar member 12B. The pillar member 12A and the pillar member 12B are pillar members connected (adjacent) to each other.

The pillar part 8 has a contact surface 13. The contact surface 13 is a surface where two pillar members 12 are in contact with each other. In the example shown in FIG. 3, the contact surface 13 is a surface where the pillar member 12A and the pillar member 12B come into contact with each other.

In the pillar part 8, a defining part 14 is provided between the pillar member 12A and the pillar member 12B. In the present embodiment, the defining part 14 is disposed on the pillar member 12A. The defining part 14 defines the contact surface 13 between the pillar member 12A and the pillar member 12B. The defining part 14 defines a size of a contact area of the contact surface 13 between the pillar member 12A and the pillar member 12B. The defining part 14 is formed of an inorganic substance which is a material different from the material (Cu) that forms the pillar part 8. In the present embodiment, the defining part 14 is, for example, Cr, titanium oxide, or the like. The defining part 14 has a conductivity lower than a conductivity of the pillar part 8.

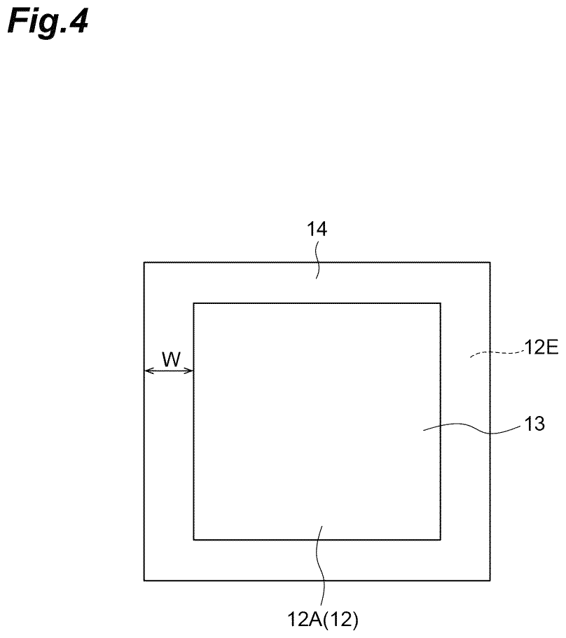

As illustrated in FIGS. 3 and 4, the defining part 14 is disposed at an edge 12E of each of the pillar members 12A and 12B when viewed from the second direction D2 (lamination direction). The edge 12E of the pillar member 12A, 12B represents a concept including a part on an inner side of side surface 12Aa, 12Ba (side surfaces of the pillar part 8) of the pillar member 12A, 12B by a predetermined distance. As illustrated in FIG. 4, in the present embodiment, the defining part 14 has a rectangular frame shape. The contact surface 13 defined by the defining part 14 has a shape similar to an outer shape of the pillar part 8. The shape of the contact surface 13 is rectangular. In other words, an inner side of the defining part 14 has a rectangular shape.

In the present embodiment, the defining part 14 defines the contact surface 13 such that the area of the contact surface 13 is 20% to 80% of an area of an end surface of the pillar member 12A, 12B. In other words, the defining part 14 is set to have a width W such that the area of the contact surface 13 is 20% to 80% of the area of the end surface of the pillar member 12A, 12B. The defining part 14 has a thickness T of, for example, 10 nm to 30 nm.

The defining part 14 is provided between two adjacent pillar members 12 among the plurality of pillar members 12. In other words, for example, when the number of the pillar members 12 is four, three defining parts 14 are provided.

The coil component 1 can be manufactured by a manner, for example, as follows. The element body 2 can be formed by laminating sheets constituting the element body layer. The coil 5 (the first wiring part 6, the second wiring part 7, and the pillar part 8), the first connection conductor 10, and the second connection conductor 11 can be manufactured using a photolithography method. The “photolithography method” is not limited by a type of a mask or the like as long as a layer to be processed containing a photosensitive material is processed into a desired pattern by exposing and developing the layer.

In the following, manufacture of the pillar part 8 will be

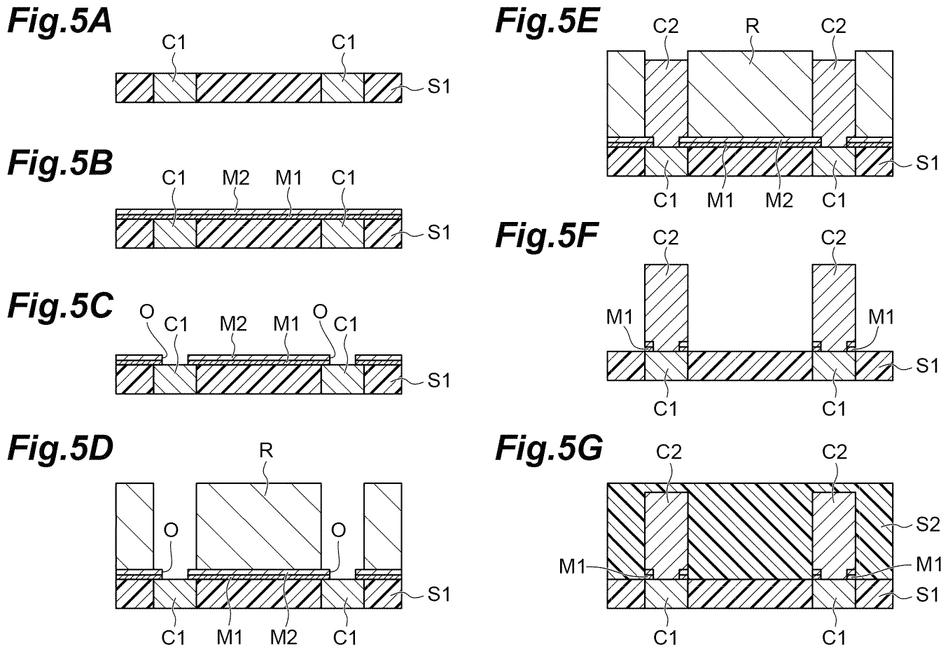

described in detail. As illustrated in FIG. 5A, in a sheet S1 constituting the element body layer, after a conductor C1 (the pillar member 12A) constituting the pillar part 8 is formed by Cu plating, the sheet S1 is ground to expose the conductor C and the sheet S1 is planarized.

Subsequently, as illustrated in FIG. 5B, a first film M1 of Cr is formed on the sheet S1 by a sputtering method, and a second film M2 of Cu is formed on the first film M1 by the sputtering method.

Subsequently, as illustrated in FIG. 5C, after a resist is spin-coated on the second film M2, a region corresponding to the conductor C1 is exposed and developed to remove the first film M1 and the second film M2 in the region corresponding to the conductor C, and an opening O is formed in the first film M1 and the second film M2. An opening area of the opening O corresponds to the area of the contact surface 13 of the pillar part 8. The area of the contact surface 13 of the pillar part 8 can be adjusted by adjusting (setting) the opening area of the opening O.

Subsequently, as illustrated in FIG. 5D, after a resist R is spin-coated on the second film M2, the resist R in a region corresponding to the conductor C is removed by exposure and development. Subsequently, as illustrated in FIG. 5E, by a plating method, a conductor C2 (the pillar member 12B) is formed in the part from which the resist R has been removed. The conductor C2 is Cu plated.

Subsequently, as illustrated in FIG. 5F, the resist R is peeled off, and the first film M1 and the second film M2 are removed. At this time, the first film M1 remains between the conductor C1 and the conductor C2. The first film M1 serves as the defining part 14. Subsequently, a sheet S2 constituting the element body layer is embedded to cure the element body layer. Thus, the pillar part 8 provided with the defining part 14 is manufactured.

As described in the foregoing, in the coil component 1 according to the present embodiment, the defining part 14 that defines the contact surface 13 between the two pillar members 12A and 12B of the pillar part 8 is provided between the two pillar members 12A and 12B. The defining part 14 is formed of a material different from that of the pillar part 8. The defining part 14 is disposed at the edges 12E of the two pillar members 12A and 12B when viewed from the second direction D2. As a result, in the coil component 1, even when misalignment in lamination occurs in the two pillar members 12A and 12B, since the contact surface 13 between the two pillar members 12A and 12B is defined by the defining part 14, the contact area of the two pillar members 12A and 12B is kept constant. Therefore, in the coil component 1, even when the misalignment occurs in the two pillar members 12A and 12B, the property is not affected. As a result, in the coil component 1, occurrence of variations in property can be suppressed.

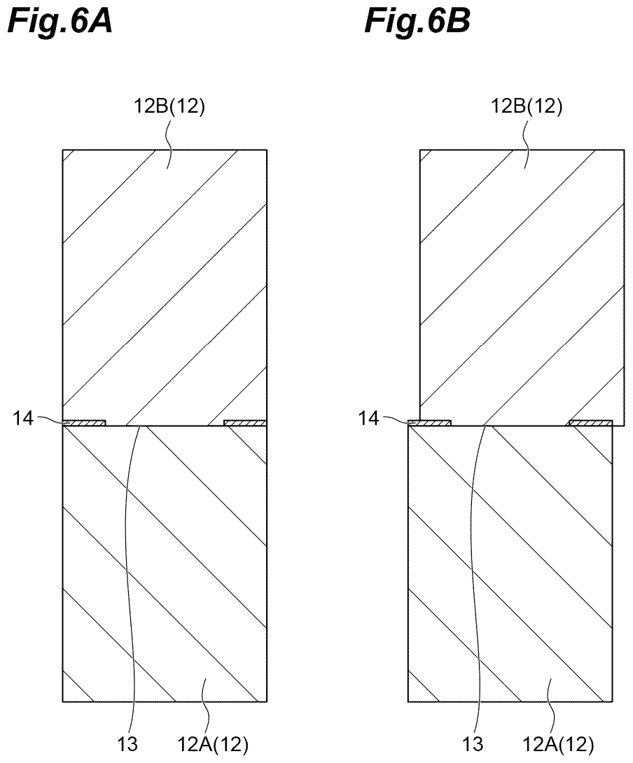

FIG. 6A is a view illustrating a state in which the two pillar members 12A and 12B are not misaligned. FIG. 6B is a view illustrating a state in which the two pillar members 12A and 12B are misaligned. As illustrated in FIG. 6B, even when the two pillar members 12A and 12B are misaligned, the area of the contact surface 13 defined by the defining part 14 is the same as the contact surface 13 (FIG. 6A) in a case where the two pillar members 12A and 12B are not misaligned. In other words, even when the two pillar members 12A and 12B are misaligned, the area of the contact surface 13 does not change. Therefore, in the coil component 1, even when the two pillar members 12A and 12B are misaligned, the property is not affected, so that occurrence of variations in property can be suppressed.

In the coil component 1 according to the present embodiment, when viewed from the second direction D2 (an extending direction of the pillar part 8), the shape of the contact surface 13 defined by the defining part 14 has the shape similar to the outer shape of the pillar part 8. In this configuration, a large allowable range of misalignment between the two pillar members 12A and 12B can be secured.

### Second Embodiment

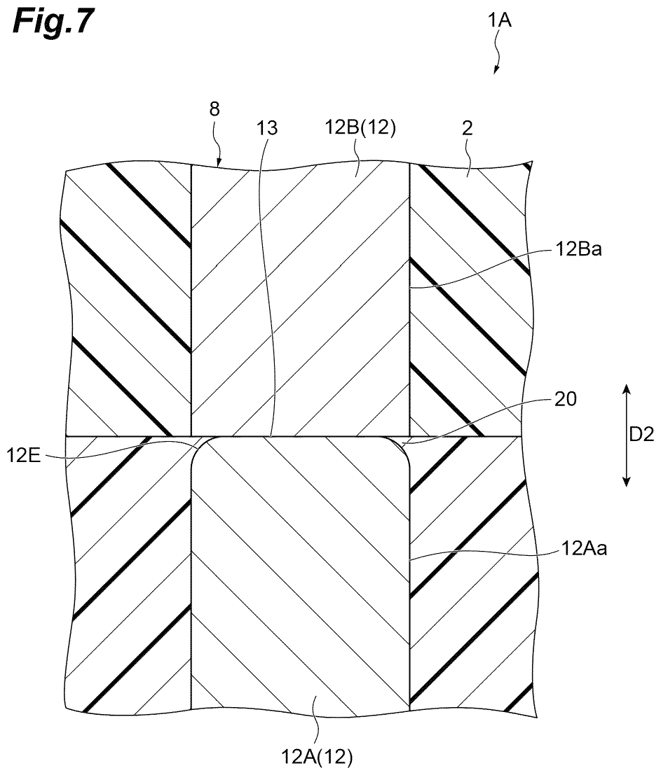

Next, a second embodiment will be described. FIG. 7 is an enlarged cross-sectional view illustrating a part of a pillar part according to the second embodiment. In a coil component 1A, a pillar part 8 is provided with a defining part 20 between a pillar member 12A and a pillar member 12B. The defining part 20 defines a contact surface 13 between the pillar member 12A and the pillar member 12B. The defining part 20 defines a size of a contact area of the contact surface 13 between the pillar member 12A and the pillar member 12B. The defining part 20 is constituted by a part of an element body 2.

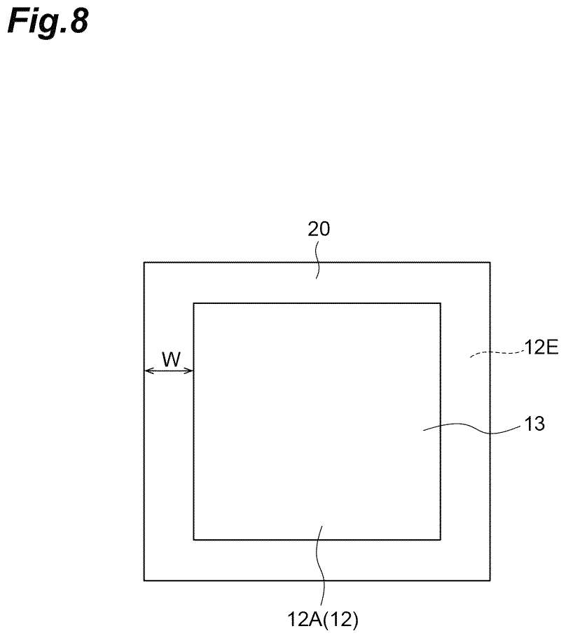

As illustrated in FIGS. 7 and 8, the defining part 20 is disposed at an edge 12E of the pillar member 12A, 12B when viewed from the second direction D2 (the lamination direction). The edge 12E of the pillar member 12A, 12B represents a concept including a part on an inner side of a side surface of the pillar member 12A, 12B by a predetermined distance. The edge 12E of the pillar member 12A is configured by a curved surface connecting a side surface 12Aa of the pillar member 12A and the contact surface 13. The defining part 20 is disposed at a position corresponding to the curved surface as viewed from the second direction D2.

As illustrated in FIG. 8, in the present embodiment, the defining part 20 has a rectangular frame shape. In the present embodiment, the defining part 20 defines the contact surface 13 such that the area of the contact surface 13 is 20% to 80% of an area of an end surface of the pillar member 12A, 12B.

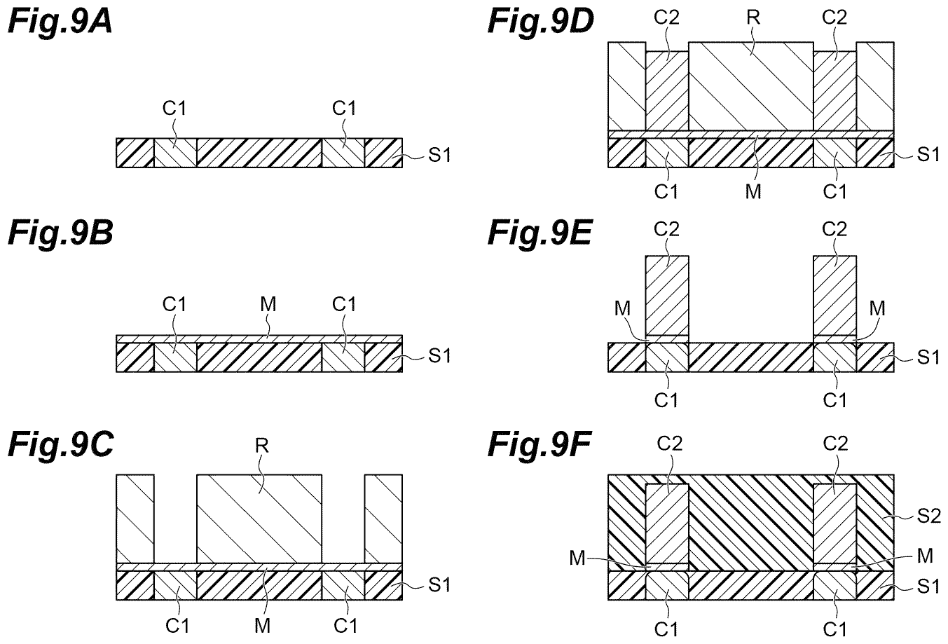

In the following, manufacture of the pillar part 8 will be described in detail. As illustrated in FIG. 9A, in a sheet S1 constituting an element body layer, after a conductor C1 (the pillar member 12A) constituting the pillar part 8 is formed by Cu plating, the sheet S1 is ground to expose the conductor C and the sheet S1 is planarized.

Subsequently, as illustrated in FIG. 9B, a Cu film M is formed on the sheet S1 by the sputtering method.

Subsequently, as illustrated in FIG. 9C, after a resist R is spin-coated on the film M, the resist R in a region corresponding to the conductor C1 is removed by exposure and development. Subsequently, as illustrated in FIG. 9D, by the plating method, a conductor C2 (the pillar member 12B) is formed in a part from which the resist R has been removed. The conductor C2 is Cu plated.

Subsequently, as illustrated in FIG. 5E, the resist R is peeled off and the film M is removed. At this time, when the film M is removed, a part of the conductor C1 is removed to form the defining part 20. Subsequently, a sheet S2 constituting the element body layer is embedded to cure the element body layer. Thus, the pillar part 8 provided with the defining part 20 is manufactured.

As described in the foregoing, in the coil component 1A according to the present embodiment, the defining part 20 that defines the contact surface 13 between the two pillar members 12A and 12B of the pillar part 8 is provided between the two pillar members 12A and 12B. The defining part 20 is formed of a material different from that of the pillar part 8. The defining part 20 is disposed at the edges 12E of the two pillar members 12A and 12B when viewed from the second direction D2. As a result, in the coil component 1A, even when misalignment in lamination occurs in the two pillar members 12A and 12B, since the contact surface 13 between the two pillar members 12A and 12B is defined by the defining part 20, the contact area of the two pillar members 12A and 12B is kept constant. Therefore, in the coil component 1A, even when the two pillar members 12A and 12B are misaligned, the property is not affected. As a result, in the coil component 1A, occurrence of variations in property can be suppressed.

Although the embodiments of the present disclosure have been described in the foregoing, the present disclosure is not necessarily limited to the above-described embodiments, and various modifications can be made without departing from the gist thereof.

In the above embodiments, the mode in which the defining part 14, 20 is provided at the edges 12E of the two pillar members 12A and 12B of the pillar part 8 has been described as an example. However, the defining part may be provided between other conductors.

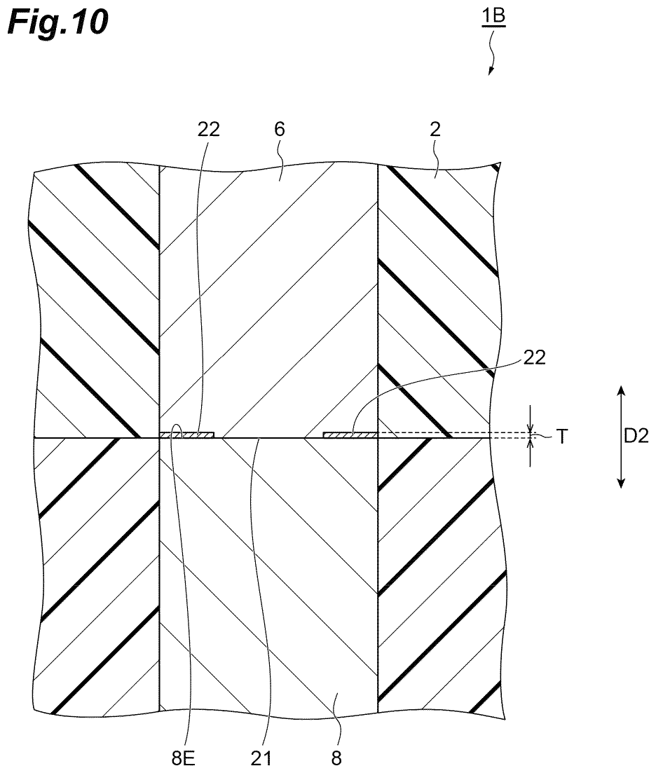

As illustrated in FIG. 10, in a coil component 1B, a pillar part 8 and a first wiring part 6 have a contact surface 21. The contact surface 21 is a surface where the pillar part 8 and the first wiring part 6 are in contact with each other. A defining part 22 is provided between the pillar part (a first conductor) 8 and the first wiring part (a second conductor) 6. The defining part 22 is disposed on the pillar part 8. The defining part 22 defines the contact surface 21 between the pillar part 8 and the first wiring part 6. The defining part 22 defines a size of a contact area of the contact surface 21 between the pillar part 8 and the first wiring part 6. The defining part 22 is formed of an inorganic material different from a material (Cu) that forms the pillar part 8 and the first wiring part 6. The defining part 22 is, for example, Cr, titanium oxide, or the like. The defining part 22 has a conductivity lower than conductivities of the pillar part 8 and the first wiring part 6.

The defining part 22 is disposed at an edge 8E of the pillar part 8 as viewed from the second direction D2 (lamination direction). The edge 8E of the pillar part 8 represents a concept including a part on an inner side of a side surface of the pillar part 8 by a predetermined distance. The defining part 22 has a rectangular frame shape. The contact surface 21 defined by the defining part 22 has a shape similar to an outer shape of the pillar part 8. The shape of the contact surface 21 is rectangular. In other words, an inner side of the defining part 22 has a rectangular shape.

The defining part 22 defines the contact surface 21 such that the area of the contact surface 21 is 20% to 80% of an area of an end surface of the pillar part 8. In other words, the defining part 22 is set to have a width such that the area of the contact surface 21 is 20% to 80% of the area of the end surfaces of the pillar part 8. The defining part 22 has a thickness T of, for example, 10 nm to 30 nm.

In the coil component 1B, the defining part 22 that defines the contact surface 21 between the pillar part 8 and the first wiring part 6 is provided between the pillar part 8 and the first wiring part 6. The defining part 22 is formed of a material different from materials of the pillar part 8 and the first wiring part 6, and is disposed at the edge 8E of the pillar part 8 when viewed from the second direction D2. As a result, in the coil component 1B, even when misalignment in lamination occurs in the pillar part 8 and the first wiring part 6, since the contact surface 21 between the pillar part 8 and the first wiring part 6 is defined by the defining part 22, the contact area of the pillar part 8 and the first wiring part 6 is kept constant. Therefore, in the coil component 1B, even when the pillar part 8 and the first wiring part 6 are misaligned, the property is not affected. As a result, in the coil component 1B, occurrence of variations in property can be suppressed.

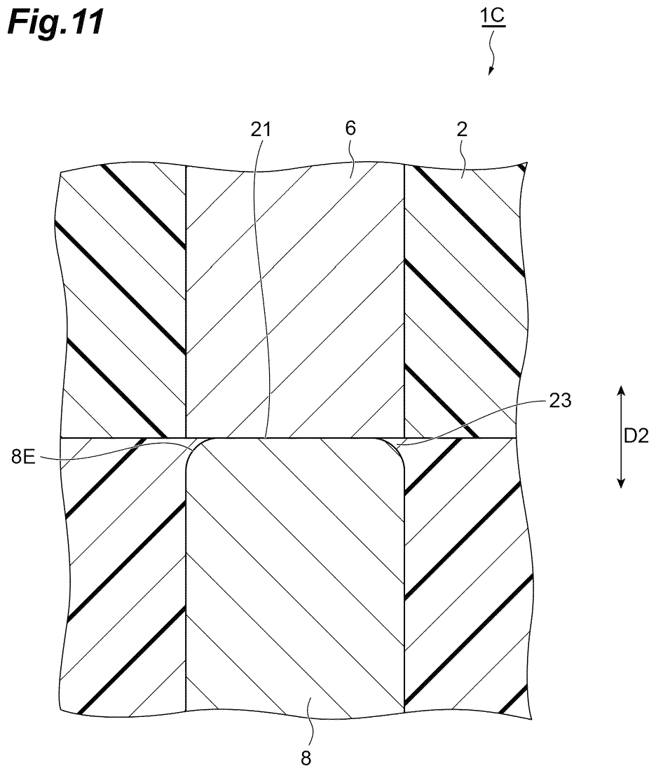

As illustrated in FIG. 11, in a coil component 1C, a defining part 23 is provided between a pillar part 8 and a first wiring part 6. The defining part 23 defines a contact surface 21 between the pillar part 8 and the first wiring part 6. The defining part 23 defines a size of a contact area of the contact surface 21 between the pillar part 8 and the first wiring part 6. The defining part 23 is constituted by a part of an element body 2.

The defining part 23 is disposed at an edge 8E of the pillar part 8 as viewed from the second direction D2 (lamination direction). The edge 8E of the pillar part 8 represents a concept including a part on an inner side of a side surface of the pillar part 8 by a predetermined distance. The edge 8E of the pillar part 8 is configured by a curved surface connecting the side surface of the pillar part 8 and the contact surface 21. The defining part 23 is disposed at a position corresponding to the curved surface as viewed from the second direction D2.

In the coil component 1C, the defining part 23 that defines the contact surface 21 between the pillar part 8 and the first wiring part 6 is provided between the pillar part 8 and the first wiring part 6. The defining part 23 is formed of a part of the element body 2, and is disposed at the edge 8E of the pillar part 8 when viewed from the second direction D2. As a result, in the coil component 1C, even when misalignment in lamination occurs in the pillar part 8 and the first wiring part 6, since the contact surface 21 between the pillar part 8 and the first wiring part 6 is defined by the defining part 23, the contact area between the pillar part 8 and the first wiring part 6 is kept constant. Therefore, in the coil component 1C, even when the pillar part 8 and the first wiring part 6 are misaligned, the property is not affected. As a result, in the coil component 1B, occurrence of variations in property can be suppressed.

Note that although in the above modification, the mode in which the defining part 22, 23 is provided between the pillar part 8 and the first wiring part 6 has been described as an example, the defining part may be provided between the pillar part 8 and the second wiring part 7.

In the above embodiment, the mode in which the first terminal electrode 3 and the second terminal electrode 4 do not protrude from the main surface 2d has been described as an example. In other words, as an example, the description has been made of the mode in which the respective surfaces of the first terminal electrode 3 and the second terminal electrode 4 are flush with the main surface 2d. The first terminal electrode 3 and the second terminal electrode 4 may, however, protrude from the main surface 2d.

What is claimed is:

1. An electronic component comprising:
an element body formed by laminating a plurality of insulator layers; and
a conductor disposed in the element body and extending in a lamination direction of the plurality of insulator layers, wherein
the conductor has a plurality of conductor members laminated in the lamination direction,
between two of the conductor members in the lamination direction, a defining part configured to define a contact surface between the two conductor members is provided, and
the defining part is formed of a material different from a material of the conductor, and is disposed at edges of the two conductor members when viewed from the lamination direction.

2. The electronic component according to claim 1, wherein
the conductor is formed of Cu, and
the defining part is formed of an inorganic substance different from Cu.

3. The electronic component according to claim 1, wherein the contact surface defined by the defining part has a shape similar to an outer shape of the conductor when viewed from the lamination direction.

4. The electronic component according to claim 1, wherein the defining part is formed of the same material as a material of the element body.

5. The electronic component according to claim 4, wherein
the edge of one of the two conductor members is configured by a curved surface connecting a side surface of the one conductor member and the contact surface, and
the defining part is disposed at a position corresponding to the curved surface when viewed from the lamination direction.

6. An electronic component comprising:
an element body formed by laminating a plurality of insulator layers;
a first conductor disposed in the element body and extending in a lamination direction of the plurality of insulator layers; and
a second conductor connected to the first conductor, wherein
between the first conductor and the second conductor, a defining part configured to define a contact surface between the first conductor and the second conductor is provided, and
the defining part is formed of a material different from materials of the first conductor and the second conductor, and is disposed at an edge of the first conductor when viewed from the lamination direction.

7. The electronic component according to claim 6, wherein
the first conductor and the second conductor are formed of Cu, and
the defining part is formed of an inorganic substance different from Cu.

8. The electronic component according to claim 6, wherein the contact surface defined by the defining part has a shape similar to an outer shape of the first conductor when viewed from the lamination direction.

9. The electronic component according to claim 6, wherein the defining part is formed of the same material as a material of the element body.
